(19) United States
(12) Patent Application Publication
(10) Pub. No.: US 2018/0119031 A1
(43) Pub. Date: May 3, 2018

(54) OIL AND WATER EMULSION DETECTION AND CONTROL FOR DESALTERS

(71) Applicant: SHELL OIL COMPANY, Houston, TX (US)

(72) Inventors: Kevin M. HAWORTH, Anacortes, WA (US); William DORMAN, Sedro Woolley, WA (US)

(21) Appl. No.: 15/793,071

(22) Filed: Oct. 25, 2017

Related U.S. Application Data
(60) Provisional application No. 62/413,528, filed on Oct. 27, 2016.

(51) Int. Cl. C10G 33/08; C10G 33/04; B01D 11/04

(52) U.S. Cl. CPC C10G 33/08; G05D 9/12; B01D 11/0484; C10G 33/04

(57) ABSTRACT

A method for detecting information concerning an emulsion layer within a desalter vessel. Liquid samples are drawn from various depths within the desalter vessel, and each sample is passed through a fluid density and flow measurement device. Information concerning the emulsion layer can be used to adjust injection of demulsifying chemical into the desalter vessel and/or the control the rate of water removal from the desalter vessel.

This Non-Provisional Application claims the benefit of U.S. Provisional Application Ser. No. 62/413,528, filed 26 Oct. 2016, the disclosures of which are incorporated herein by reference.

The invention relates to devices and methods used to detect and provide information about an oil and water emulsion layer within a liquid-containing vessel, such as a crude oil desalter vessel. In other aspects, the invention relates to methods for desalting crude oil and for controlling a crude oil desalter unit.

Crude oil often contains salts, such as calcium, sodium and magnesium chlorides, and other contaminants that must be removed before the oil can be further refined. These salts and contaminants can cause problems with downstream processing equipment and contamination of the final refined products that decreases their value.

Salts are typically removed from crude oils by mixing water with the crude oil followed by separation of the water and oil phases to yield a desalted crude oil. The water is mixed with crude oil to form a mixture of oil, water and an emulsion of the two. The mixture is then fed to a desalter unit that provides for separation of the water and crude oil phases to yield desalted crude oil and a water effluent containing salts removed from the crude oil.

A desalter unit generally includes a large vessel equipped with electrodes for providing an electrostatic field to promote droplet coalescence within the separation zone defined by the vessel. The desalter unit provides for gravitational and electrostatic separation of the crude oil and water mixture into distinct oil and water layers.

Within the desalter vessel is typically formed an oil and water emulsion layer between an upper oil layer and a lower water layer. This layer of oil and water emulsion within the desalter vessel can vary in thickness or depth from a few centimeters to as much as several meters. The effectiveness of salt removal techniques can depend upon the method of controlling operation of the desalter unit and controlling the location and thickness of the oil and water emulsion layer within the desalter vessel.

Accordingly, provided is a method for desalting a crude oil and controlling a desalting unit. This method comprises introducing a feed, comprising oil, water and an oil/water emulsion, into a vessel having an oil outlet for removing oil from the vessel and a water outlet for removing water from the vessel. Within the vessel is provided an emulsion layer having a depth and positioned between a lower water layer, having a water level within the vessel, and an upper oil layer. A plurality of liquid samples from a plurality of distinct depths within the vessel is removed from the vessel and each of the plurality of liquid samples is passed through a fluid density and flow measurement device for measuring a specific gravity value of each of the plurality of liquid samples. The specific gravity values are processed to yield an emulsion output signal indicative of an emulsion profile and an emulsion depth.

In another embodiment of the invention, a feed, comprising oil, water and an oil/water emulsion, is introduced into a vessel having an oil outlet for removing oil from the vessel and a water outlet for removing water from the vessel. The feed is allowed to separate within the vessel into an emulsion layer positioned between a lower water layer and an upper oil layer. Water is removed from the lower water layer at a water removal rate through the water outlet. A plurality of liquid samples is removed from a plurality of distinct depths within the vessel and each of the plurality of liquid samples is passed through a fluid density and flow measurement device for measuring the specific gravity of each of the plurality of liquid samples to provide a measured specific gravity value for each of the plurality of liquid samples. The water removal rate is controlled based upon the measured specific gravity values.

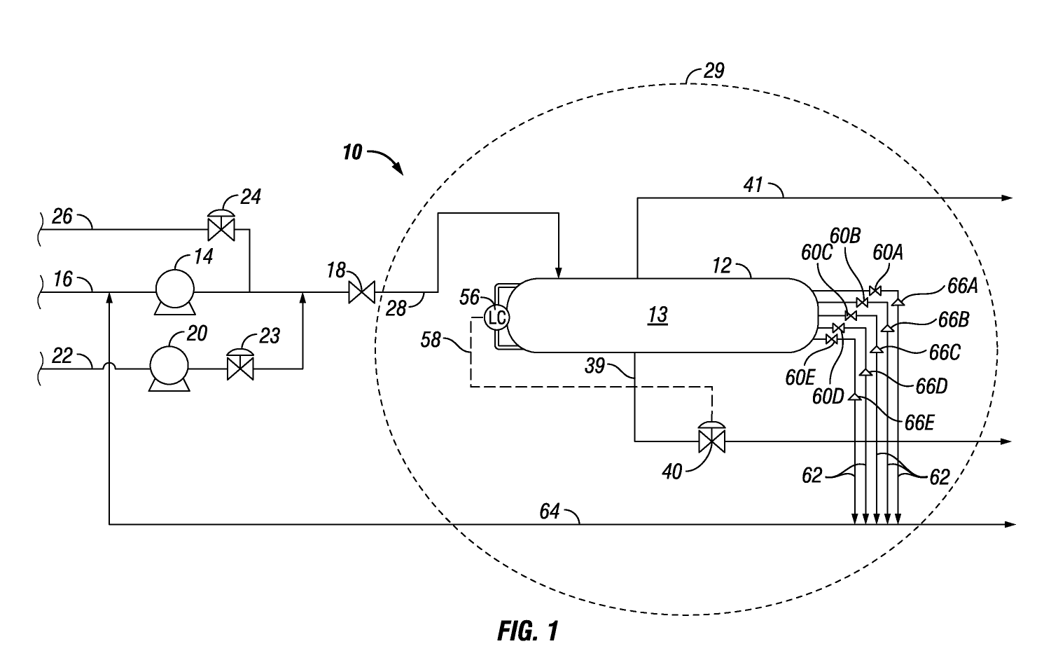

FIG. 1 is a process flow diagram representing a process for desalting crude oil. The process includes use of a desalter vessel and associated components for desalting crude oil.

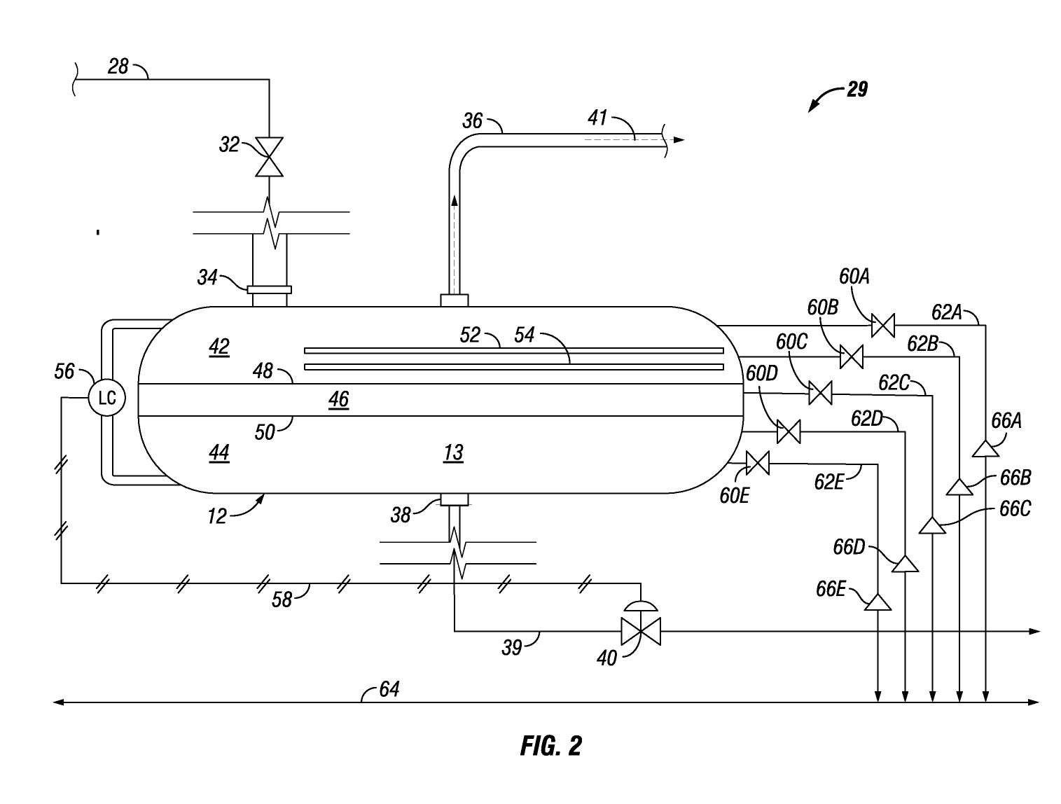

FIG. 2 is an exploded cross-sectional side view of the desalter unit of the process of FIG. 1.

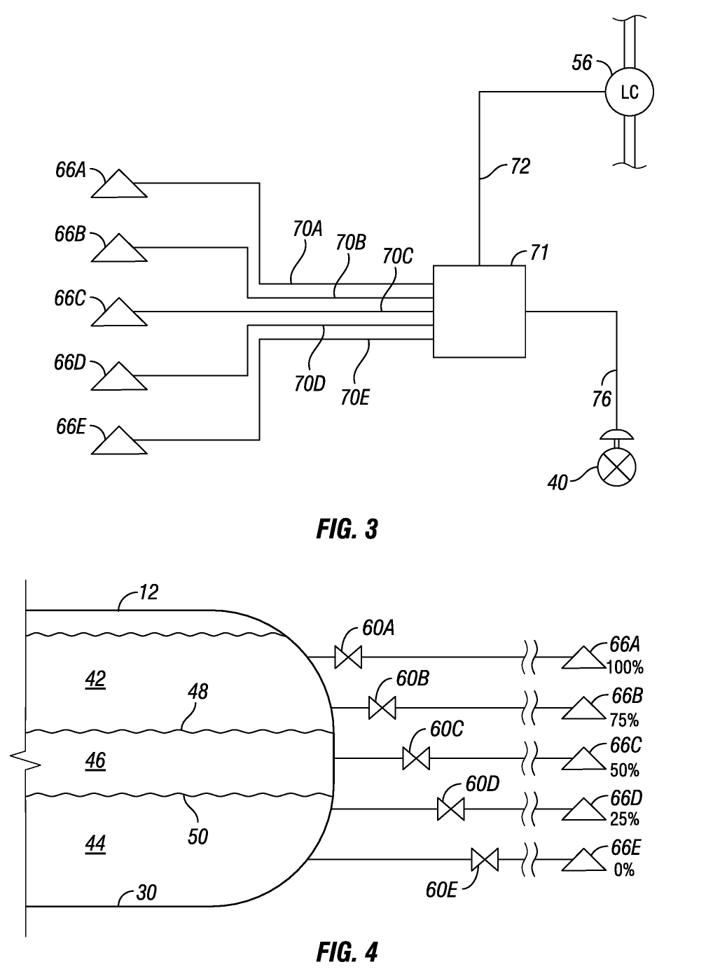

FIG. 3 is a schematic depiction of a control arrangement for desalting processes.

FIG. 4 illustrates detection of an emulsion layer location within a desalter vessel in accordance with the present invention.

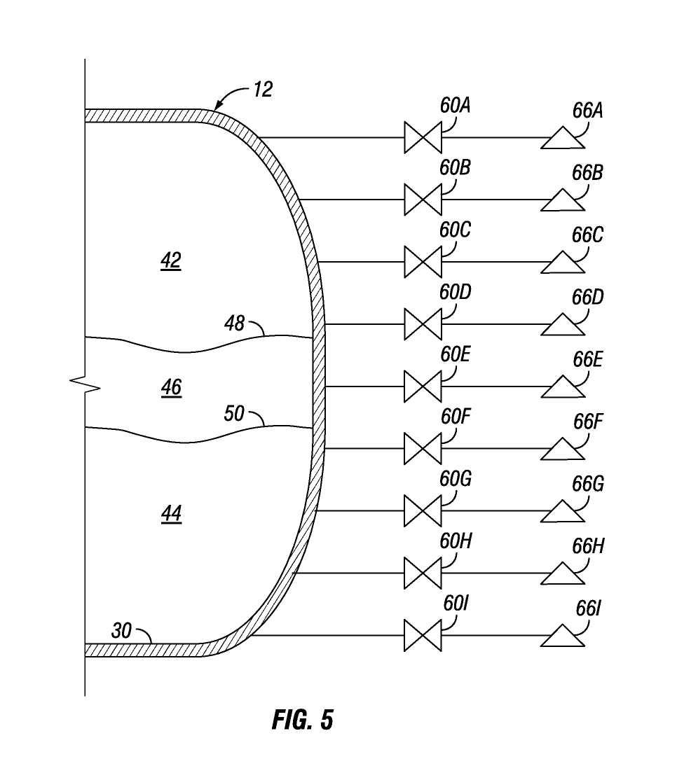

FIG. 5 illustrates an arrangement for detection of an emulsion layer profile in accordance with the present invention.

The invention includes an emulsion layer detection system that can determine the location of an emulsion layer contained within the separation or settling zone defined by a crude oil desalter vessel. The emulsion layer detection system provides information about the thickness and composition of the emulsion layer that is formed within the desalter vessel. This information is used in controlling and breaking the emulsion layer and in controlling the rate of removal of water from the desalter vessel.

Such terms as “emulsion” or “emulsion layer” or “oil/water emulsion” refer herein to a dispersion of two or more immiscible liquids, such as crude oil and water, wherein at least one liquid phase is dispersed within another liquid phase. These terms, however, do not distinguish between an oil-in-water dispersion and a water-in-oil dispersion. That is to say, the references in this specification to an emulsion are to any type of dispersion of immiscible liquids (e.g., crude oil and water), including oil-in-water emulsions, wherein oil is the dispersed phase, or water-in-oil emulsions, wherein water is the dispersed phase, or multiple emulsions such as water-in-oil-in-water emulsions and oil-in-water-in-oil emulsions.

The crude oil component of the feed mixtures and emulsions of the invention includes hydrocarbons obtained from a geological structure or any hydrocarbon fraction of a crude oil obtained from a geological structure. Crude oil fractions include gasoline, diesel, kerosene, fuel oil, light vacuum gas oil, heavy vacuum gas oil as well as higher molecular weight hydrocarbon compounds.

The emulsion layer formed within the separation or settling zone of the crude oil desalter vessel includes an emulsified mixture that comprises a dispersed liquid phase and a continuous liquid phase. The dispersed liquid phase can be either crude oil or water depending upon the relative volumes of crude oil and water and the physical characteristics of the crude oil.

Typically, the emulsion layer comprises a water-in-oil emulsion, which can include emulsified water in an amount in the range of upwardly to 80 volume percent of the emulsion layer, and, more typically, in the range of from 1 vol. % to 60 vol. %. For crude oils having an API gravity of greater than about 20 degrees) (20°) (light crudes), the amount of water emulsified in the crude oil can be in the range upwardly to 25 vol. %, and, more typically, from 5 vol. % to 20 vol. %. For crude oils having an API gravity of less than about 20° (heavy crudes), the amount of water emulsified in the crude oil can be in the range 5 vol. % to 40 vol. %, and, more typically, from 10 vol. % to 35 vol. %.

The relative amounts of water and oil in the emulsion layer varies throughout its depth within the desalter vessel. For example, the ratio of oil-to-water of the emulsion layer at the upper-end boundary of the emulsion layer is greater than the ratio oil-to-water of the emulsion layer at its lower-end boundary.

The desired thickness or height of the emulsion layer formed within the separation zone of the desalter vessel varies with the size, e.g., the diameter, of the desalter vessel. The thickness of the emulsion layer is controlled by the inventive method to within the range of from a few centimeters to several meters. For example, for horizontal desalter vessels, the emulsion layer thickness can be controlled within the range of from less than 1% to about 60% of the desalter vessel diameter, preferably, from or less than 3% to 40% of the vessel diameter, and, more preferably, from or less than 5% to 30% of the vessel diameter.

One important aspect of the invention is that it provides for the measurement and control of the properties and thickness of the emulsion layer. The invention also provides for controlling and maintaining the location of the emulsion layer within the separation zone of the desalter vessel at a desired level. The desired level of the emulsion layer is below the level of the internal electrodes and at a sufficient distance above the water outlet of the desalter vessel so that emulsified water and oil does not pass with effluent water from the desalter vessel.

An emulsion layer within the desalter vessel that contains more than about 20 vol. % water can create a hazard if it comes too close to the internal electrodes so as to cause the electrodes to short out and shutdown the desalter. Alternatively, if the emulsion layer's lower boundary moves downwardly toward and close to the water outlet of the desalter vessel, oil can pass with the desalter effluent water from the desalter vessel through its water outlet. The invention provides for controlling the properties of the emulsion layer and maintaining the location of the emulsion layer within the desalter vessel to minimize these problems.

A desalter vessel defines an interior volume or separation zone into which a feed, comprising a mixture of crude oil, water and an oil/water emulsion, is introduced. The desalter vessel has multiple liquid sampling ports in a plurality of locations that permit the withdrawal of liquid samples from various depths within the chamber. Fluid conduits interconnect each liquid sampling port with a sampling line. A fluid density and flow measurement device is associated with each liquid sampling port that is capable of measuring the specific gravity of the fluid removed at each of the associated liquid sampling ports.

The fluid density and flow measurement device is operable and provides for measuring volumetric or mass flow and specific gravity of each liquid sample removed from the desalter vessel separation zone. In preferred embodiments, each fluid density and flow measurement device is a Coriolis meter or mass flow meter. The fluid density and flow measurement devices provide output signals to a process controller that are indicative or representative of the respective measured fluid densities or specific gravities.

In accordance with preferred embodiments, a process controller receives the output signals from the fluid density measurement devices that is representative of the specific gravity of each fluid, processes the specific gravity information relating to the samples, and generates a responsive output signal that is representative of the emulsion profile and depth within the separation zone of the desalter vessel. This output signal provides for controlling the crude oil desalting process and the operation of the desalter unit.

The process controller may provide information to an operator or an automatic control system that uses the information to adjust a chemical addition rate of a chemical additive into the desalter vessel for demulsifying the oil and water emulsion. The chemical additive typically is either an emulsion breaker or reverse emulsion breaker that is useful for removing salt from the emulsion layer.

The process controller provides for adjusting the rate at which water is removed from the desalter vessel through the water outlet in response to output signals from the fluid density measurement devices.

In particular embodiments, a water level sensor provides for determining the water level within the desalter vessel. This water level sensor is operable for measuring the water level within the desalter vessel and for providing to the process controller a water level signal that is representative of the water level within the desalter vessel. In response to the water level signal, the process controller adjusts the rate of water removal from the desalter vessel through the water outlet. The water removal rate from the desalter vessel may further be controlled in response to both the water level signal and the emulsion output signal and, thus, control the profile and depth of the emulsion layer within the desalter vessel.

More specifically, the inventive method provides for determining the characteristics of an emulsion layer within a desalter vessel and for locating the level, thickness and location of an emulsion layer within a desalter vessel. It does this by withdrawing a plurality of liquid samples from a plurality of depths within the desalter vessel. Each of the samples is passed through a fluid density and flow measurement device, such as a Coriolis meter, that measures the specific gravity of each of the plurality of liquid samples. Based upon these measurements, an emulsion layer profile is developed that provides information as to the water level, the thickness of the emulsion layer, and the locations of the water-emulsion and oil-emulsion interfaces within the desalter vessel.

The systems and methods of the invention advantageously generate an emulsion layer profile without resort to devices that are inserted inside the desalter vessel. The inventive method provides for measuring the specific gravity of the fluids within the desalter vessel at various locations to provide a plurality of specific gravity values that are processed by a process controller that generates an emulsion output signal representative of the profile, thickness and location of the emulsion layer within the desalter vessel. The process controller does this by correlating measured emulsion specific gravity and depth information to a yield an emulsion output signal that is indicative or representative of an emulsion profile and emulsion depth. One way this is done is by linear interpolation of information to calculate the locations of the oil-emulsion boundary and the water-emulsion boundary.

The invention further provides other improved techniques for controlling certain aspects of the desalting process. For instance, the chemical injection rate of demulsifying chemical may be adjusted based upon the information detected concerning the emulsion layer. The rate of removal of water from the desalter vessel may also be adjusted in response to the emulsion output signal that is representative of the emulsion profile and emulsion depth within the desalter vessel. The water level within the desalter vessel is additionally controlled to adjust the location (depth) of the emulsion layer within the desalter vessel and to prevent loss of oil through the water outlet of the desalter vessel.

The emulsion layer measurement may further be used in combination with the water level measurement device, e.g., a level sensor, to control the water removal rate from the desalter vessel. A water level sensor is operatively associated with the desalter vessel, and it measures the water level within the vessel. The water level sensor provides a water level signal to a process level controller that adjusts or controls the water removal rate from the desalter vessel in response to either or both of the emulsion output signal and the water level signal. In general operation, a crude oil feed is first emulsified with fresh wash water to permit salts within the crude oil feed to be dissolved into the water of the emulsion. This emulsification of the crude oil feed with water feed is performed by mixing means, which may be a static mixer, mixing valve or a propeller that creates turbulence for mixing oil with fresh wash water.

Mixing means will produce an oil and water emulsion to ensure good contact between the oil and wash water to favor removal of soluble salts by the water as well as promotion of solids separation. The wash water may be obtained from various sources, such as recycled refinery water, recirculated wastewater, clarified water, purified wastewater, sour water stripper bottoms, overhead condensate, boiler feed water, clarified river water or any other suitable source.

The amount of fresh or wash water blended with the crude oil varies depending upon its API gravity; however, the amount of water mixed is typically in the range of from about 1% to 25%, more typically, from 3% to 10%, of the amount of crude oil. The emulsified mixture is flowed as a feed into the desalter vessel and allowed to separate within the separation zone of the desalter vessel into distinct oil and water layers, with an emulsion layer located or positioned between an upper oil and a lower water layer. As the phases separate, the water layer then contains an increased amount of salt that has been removed from the oil and the oil has a reduced salt concentration (i.e., desalted crude oil).

The feed introduced into the desalter vessel, thus, comprises crude oil mixed with wash water and any injected demulsifying chemical that is added and mixed with the crude oil and water. Therefore, it includes an oil phase, a water phase and an emulsion of oil and water.

Separation of the emulsion layer is preferably aided by energizing a pair of electrodes to generate an electric field within the desalter chamber and by the addition of demulsifying chemical to the desalter chamber. An electric field is generated within the desalter vessel with electrodes to assist separation and help break the emulsion layer. In particular embodiments, electric potentials from about 15,000 to about 35,000 volts are used.

To illustrate how the invention provides systems and methods for controlling the water level within the desalter vessel, consider the situation of when the rate of water removal from the desalter vessel is large enough to cause oil to pass with the water as it is removed from the vessel. In such a situation, the fluid density and flow measurement devices (Coriolis meters) measuring fluid taken from the lower portion of the desalter vessel will detect a reduced specific gravity in the water layer. This indicates the presence of oil within the water layer and, therefore, a need to raise the water level within the desalter vessel. In response, the process controller processes the information from the Coriolis meters to provide an output signal that provides for a decrease in the rate of water removal from the desalter vessel.

The invention also provides systems and methods for controlling the position or level of the emulsion layer within the desalter vessel. The water removal rate from the desalter vessel is increased or decreased as necessary to adjust the vertical depth or position of the emulsion layer within the desalter vessel. It is generally desirable to adjust the vertical depth or location of the emulsion layer to be located near or around the center (depthwise) of the vessel. Locating the emulsion layer near the center of the desalter vessel allows for improved detection of emulsion layer thickness and composition.

In described embodiments, readings from the fluid density and flow measurement devices are used to control the addition of demulsifying chemical into the desalter vessel to break the emulsion layer into oil and water constituents. The demulsifying chemical can include emulsion-breaking substances such as surfactants, pH modifiers, solids removal agents and the like. Particularized information about the composition of the emulsion layer can be used by emulsion breaking specialists to adjust the type of demulsifying chemical used or its rate of addition to the desalter vessel. The particularized information is derived from several density measurements made at various depths within the emulsion layer itself.

In particular embodiments, the fluid density and flow measurement device is a Coriolis meter. The Coriolis meter provides for the measurement of fluid density by passing the fluid through a vibrating U-shaped tube causing a change in its vibration frequency relative to the vibration frequency of the U-tube without the fluid flowing through it. There is a relationship between the vibration frequency of the U-shaped tube of the Coriolis meter when a fluid is flowing through it and the fluid density. This relationship allows for detecting and measuring the specific gravity of fluid that passes through the U-shaped tube of the Coriolis meter.

This use of the Coriolis meters provides for rapid measurement of the specific gravities of the liquid samples extracted from the separation zone of the desalter vessel. A distributive control system processes the density measurements of the liquid samples and displays the resulting information to provide real-time analysis of the profile and depth of the emulsion layer within the desalter vessel and rapid control response to changes in the characteristics, thickness and location of the emulsion layer within the desalter vessel.

The use of the Coriolis meters of the inventive method is advantageous because they are located outside the desalter vessel. They allow for the external measurement of liquid samples that are withdrawn from a plurality of distinct depths within the desalter chamber, passed through the Coriolis meters, and then discharged to any suitable lower-pressure downstream destination. Typically, the liquid samples are fed back into the crude oil feed on the upstream side of the crude oil charge pump to the desalter unit.

FIG. 1 is a flow schematic that illustrates desalting process 10, which includes desalter vessel 12 and associated elements used in desalting crude oil. Desalter vessel 12 defines a volume or separation zone 13.

Crude oil charge pump 14, interposed in conduit 16, passes crude oil to mixing means 18. Water pump 20 flows fresh wash water through conduit 22 to mixing means 18.

Mixing means 18 provides for the intimate mixing of crude oil and fresh water to provide a mixture, comprising crude oil, water and an oil/water emulsion. Examples of suitable mixing means include static mixers, mixing valves, globe valves, and propellers that provide a pressure drop and turbulence for mixing the oil with water and promoting formation of small droplets of oil and water. The pressure drop across mixing means 18 is typically between 5 to 60 psi.

Water flow control valve 23 is interposed in conduit 22 downstream from water pump 20 and provides means for controlling the amount of fresh water that is mixed with the crude oil passing through conduit 16. The amount of wash water that is mixed with the crude oil depends on the API gravity of the crude oil, but it can be in the range of from 1 vol. % to 20 vol. %, based on the volume of crude oil. More typically, the volumetric ratio of wash water-to-crude oil mixed in the desalting process is in the range of from 2 vol. % to 15 vol. %, and, more typically, the volumetric ratio is in the range of from 3 vol. % to 10 vol. %.

Chemical additive injection valve 24 that is interposed in conduit 26 provides means for controlling the amount of demulsifying agent or other chemicals that are introduced into the crude oil feed passing through conduit 16. The amount of chemical additive introduced into the crude oil feed is adjusted in response to information gathered in accordance with the methodology described in detail below concerning the characterization of the emulsion layer within separation zone 13 of desalter vessel 12.

The mixture of crude oil, water, and oil/water emulsion passes from mixing means 18 through conduit 28 and is introduced into separation zone 13 of desalter vessel 12 of desalter unit 29.

Desalter unit 29 shown in FIG. 1 is described in detail below with reference to FIG. 2. It is understood that the identification numbers in FIG. 1 for each element of desalter unit 29 are the same as those of FIG. 2.

FIG. 2 is an exploded view of desalter unit 29 as is shown in FIG. 1 but in further detail illustrating separation zone 13 that is defined by desalter vessel 12. Desalter vessel 12 includes a liquid inflow valve 32 for controlling the introduction of the feed mixture passing through conduit 28 into separation zone 13 through feed inlet 34.

Desalter vessel 12 further includes oil outlet 36, which provides for removing oil from within separation zone 13, and a water outlet 38, which provides for removing water from within separation zone 13.

Conduit 39 is operatively connected to water outlet 38 through which water passes to downstream from separation zone 13. Interposed in conduit 39 is level control valve 40, which provides for adjusting the rate of water removal from separation zone 13 in response to changes in the water level 50. Conduit 41 is operatively connected to oil outlet 36 through which desalted oil passes to the downstream for further processing (not shown).

The feed, comprising a mixture of crude oil, water, and oil/water emulsion, is separated into an upper oil layer 42 and a lower water layer 44. Oil/water emulsion (emulsion) layer 46 is located between upper oil layer 42 and lower water layer 44 and is delineated by an upper oil-emulsion boundary 48 and a lower water-emulsion boundary 50. The water-emulsion boundary 50 also corresponds to a water level for water layer 44.

Preferably, separation zone 13 contains an electrostatic precipitator of a type known in the art. Upper electrode 52 and lower electrode 54 are located within separation zone 13 and are operable to cause salt to precipitate out of the oil layer 42 toward the water layer 44 as is known in the art. Electric potentials from about 15,000 to about 35,000 volts are typically used.

Water level sensor 56 is located within or external to desalter vessel 12 and is operable and provides means for detecting water level 50 within separation zone 13 and for generating a water level signal 58 that is indicative or representative of water level 50. Any suitable level sensor may be used for water level sensor 56. Such means include, for example, displacer level sensors, capacitance level sensors, hydrostatic pressure level sensors, and ultrasonic level sensors. Level control valve 40 controls the flow of water through water outlet 38 and conduit 39 in response to signal 58 to thereby control the water level or water-emulsion boundary 50 within separation zone 13.

Liquid sampling ports 60a, 60b, 60c, 60d and 60e are located at multiple locations in the desalter vessel 12 so that fluid can be drawn from various heights or depths within separation zone 13. In the depicted embodiment, there are five liquid sampling ports 60a-60e. However, there may be more or fewer than five such ports. The liquid sampling ports 60a-60e are located at different vertical heights along desalter vessel 12 so that liquids extracted will be drawn from different depths within separation zone 13. It is preferred for liquid sampling ports 60a-60e to be spaced apart from one another at substantially equal intervals.

Liquid conduits 62a-62e respectively extends from each liquid sampling port 60a-60e to a sampling line 64. Sampling line 64 is fluidly connected and extends to conduit 16 on the upstream side of crude oil charge pump 14. As a result, the extracted liquids are recycled to separation zone 13.

Coriolis meters 66a, 66b, 66c, 66d and 66e are respectively and operably associated with each liquid conduit 62a-62e and sampling port 60a-60e. Each Coriolis meter 66a-66e provides means for measuring both density and mass flow rate of fluid flowing through its respective liquid conduit 62a-62e.

Coriolis meters are known fluid density and flow measurement devices. Coriolis meters use the Coriolis principle to make these measurements. Fluid density can be directly measured with a Coriolis meter which flows fluid through a vibrating U-shaped tube. The fluid flow through the U-shaped tube and its density alters the oscillation frequency of the vibrating U-shaped tube. The resulting oscillation frequency is a function of the fluid density and mass flow rate. A suitable Coriolis meter for use in desalting process 10 is commercially available from Emerson Micro Motion of Boulder, Colo.

As each liquid sample is passed through its respective Coriolis meter 66a-66e, the specific gravity of the liquid is measured. Water has a specific gravity of around 1.0. Crude oil has a specific gravity which can be in the range from about 0.5 to 0.9, and more typically in the range of from 0.6 to 0.88 or from 0.76 to 0.86. A mixture of oil and water would have a specific gravity which is between the two values.

Referring now to FIG. 3, each Coriolis meter 66a-66e generates its respective output signal 70a-70e, which is indicative or representative of the measured specific gravity value of the sample fluid flowing through liquid conduits 62a-62e. Process controller 71 receives output signals 70a-70e and processes the specific gravity and mass flow information to yield at least one output signal 76 that is indicative of the emulsion profile and emulsion depth of emulsion layer 46 within separation zone 13.

In preferred embodiments, process controller 71 is a distributive control system (DCS). A DCS is a programmable computer configured for receiving and processing output signals 70a-70e that are representative of the specific gravity of the liquid samples taken from separation zone 13 to generate at least one output signal that is indicative or representative of the emulsion profile (i.e., specific gravity measurements) and corresponding emulsion depth within separation zone 13.

In particular embodiments, an emulsion profile is developed by first correlating the depths at which individual samples are drawn from the desalter vessel 12 with the specific gravity values for those samples. The depths of each of the liquid sampling ports 60a-60e are known. Measured specific gravity values are linearized and interpolated to determine intermediate values which would yield calculated depths for the oil-emulsion boundary 48 and the water-emulsion boundary 50. This information indicates the thickness or depth of emulsion layer 46.

In particular embodiments, the process controller outputs display results indicative of output signal 76. This display may be by way of computer screen or printout or other display techniques known in the art. The displayed information can be in the form of graphs, charts or numerical values.

Process controller 71 may further be configured to receive water level signal 58 as well as output signals 70a-70e. Process controller 71 provides for the processing of these signals to generate control signal 76 which provides for the responsive adjustment of level control valve 40 for controlling water level 50 and the depth of emulsion layer 46.

It is noted that the communication paths for output signals 70a-70e may be electrical conduits or wireless communication links or means. Similarly, the signal communication path for output signal 72 from water level meter 56 to process controller 71 may be an electrical conduit or wireless communication link or means.

In operation, process controller 71 receives input signals from Coriolis meters 66a-66e and is configured to determine an emulsion depth and an emulsion profile based upon the measured specific gravity values provided and represented by the output signals from Coriolis meters 66a-66e.

FIG. 4 depicts the measurement of a simplified emulsion profile for the desalter vessel 12. In particular, the measurements provided by Coriolis meters 66a-66e are used to determine a location, depth and other information for emulsion layer 46 within separation zone 13.

As indicated in FIG. 4, liquid sampling ports 60a, 60b, 60c, 60d and 60e are located at heights within separation zone 13 of 100%, 75%, 50%, 25% and 0%, respectively. The specific gravity of emulsion layer 46 should transition linearly from upper oil layer 42 down to lower water layer 44.

Linearizing the data points allows for the approximation of the emulsion layer profile. Also, the locations of oil-emulsion interface 48 and water-emulsion interface 50 can be determined by calculation based upon the missing density (specific gravity) values. An emulsion profile is determined which can include the location and thickness of emulsion layer 46 within the separation zone 13 as well as the locations of oil-emulsion interface 48 and water-emulsion interface 50.

In the example provided by FIG. 4, a user can determine a general location for emulsion layer 46 since the reading from Coriolis meter 66c indicates that emulsion layer 46 is present at the location of the liquid sampling port 60c. Thickness of emulsion layer 46 is understood not to be excessive, since it does not extend upwardly within the separation zone 13 to the point where it is detected by Coriolis meter 60b or downwardly within separation zone 13 to the point where it would be detected by Coriolis meter 60d.

For the exemplary arrangement shown in FIG. 4, the upper Coriolis meters 66a an 66b would indicate a specific gravity of about 0.5-0.8 depending upon the type of crude oil making up oil layer 42. A specific gravity within this range is indicative of an oil layer 42. The lower Coriolis meters 66d and 66e would each indicate a specific gravity of about 1.0, indicating water layer 44.

The central Coriolis meter 66c would indicate an intermediate specific gravity value (i.e., a value between 1.0 [water] and the 0.5-0.8 specific gravity of the crude oil) which is indicative of the presence of emulsion layer 46. The oil-emulsion boundary 48 can be inferred to be located between liquid sampling ports 60b and 60c. The water-emulsion boundary 50 is located between liquid sampling ports 60c and 60d. By locating these boundaries 48 and 50, the approximate thickness and location of emulsion layer 46 can be known.

Greater accuracy, detail and more particularized information concerning emulsion layer 46, its location, thickness and composition, can be obtained by increasing the number of liquid sampling ports 60 and Coriolis meters 66 and/or by locating liquid sampling ports 60 nearer to the location of emulsion layer 46 within the desalting vessel 12.

As used herein, the term “particularized information” refers to information which is derived from several density measurements made at various depths within the emulsion layer itself. An increased number of liquid sampling ports 60 and Coriolis meters 66 can also provide for enhanced error handling of measurements (i.e., data quality checking) and improved resolution (accuracy) of the calculated interface levels.

FIG. 5 illustrates an increased number of such sampling ports 60 and Coriolis meters 66. In FIG. 5, there are nine fluid density and flow measurement devices 66a, 66b, 66c, 66d, 66e, 66f, 66g, 66h and 66i. Further, the sampling ports 60 are located in locations on desalter vessel 12 that are expected to include emulsion layer 46 and its boundaries, provided by the oil-emulsion boundary 48 and the water-emulsion boundary 50. The particularized information allows a user to derive a profile of emulsion layer 46 which indicates the thickness of emulsion layer 46 as well as its composition.

In the arrangement shown in FIG. 5, upper sampling ports 60a and 60b are positioned to sample oil layer 42 and Coriolis meters 66a and 66b should yield a specific gravity reading in the range of from 0.5 to 0.8 depending upon the type of crude oil making up oil layer 42 and which indicates that oil layer 42 is present at those locations. Lower sampling ports 60h and 60i are positioned to sample the water layer 44. Associated fluid density and flow measurement devices 66h and 66i will provide a specific gravity reading of about 1.0, indicating that water layer 44 is present at that location.

Coriolis meters 66c-66g all receive samples of emulsion layer 46 and provide specific gravity readings which are indicative of the emulsion layer composition. Density of emulsion layer 46 can normally be expected to vary in a linear fashion from water-emulsion boundary 50 (most dense) to the oil-emulsion boundary 48 (least dense). An imbalance in this linear variance can indicate that the demulsifying chemical feed should be adjusted. As an example, higher than expected (i.e., outside of a linear variance) density reading for Coriolis meters 60d and/or 60e might indicate excess water in the upper portions of emulsion layer 46, which could be addressed by adjustment of demulsifying chemical. However, particularized information about the composition of the emulsion layer will provide to demulsifying chemical specialists information that is useful for determining the amounts and type of demulsifying chemicals to be added to the desalter vessel 12 via the chemical feed 26 or their rates of addition. The rate of addition of demulsifying chemical can be adjusted using valve 24.

Reduced density readings by the lower Coriolis meters 66h and 66i may indicate that excess crude oil is undesirably being pulled from emulsion layer 46 into water layer 44 and would thus lost by removal through the water outlet 38. In this event, process controller 71 would generate an output indicating to a user that the feed of demulsifying chemical should be increased to ensure more complete demulsification of emulsion layer 46.

In another aspect of the invention, information regarding emulsion layer 46 is used to control the location of emulsion layer 46 within separation zone 13. In preferred embodiments, emulsion layer 46 is directed toward the center (depthwise) portion of separation zone 13. Process controller 71 would detect the approximate locations of the boundaries 48 and 50 of emulsion layer 46 thereby locating emulsion layer 46. If emulsion layer 46 is not located proximate a central depth within separation zone 13, process controller 71 or an operator could take action to adjust the location of emulsion layer 46 within separation zone 13. Process controller 71 could increase the water removal rate to move emulsion layer 46 downwardly within separation zone 13. Alternatively, process controller 71 could decrease the water removal rate to move emulsion layer 46 upwardly within separation zone 13.

Process controller 71 provides output signal 76 providing the basis for which chemical injection valve 24 is adjusted to change the chemical addition rate to separation zone 13. In accordance with some embodiments, the chemical addition rate is adjusted, typically manually, in response to output signal 76. In these embodiments, the chemical addition rate can be increased or decreased based upon the detected location and composition of emulsion layer 46.

In alternative embodiments, the chemical addition rate is adjusted in response to the water level signal. In still other embodiments, the chemical addition rate is adjusted in response to both the output signals and the water level signal.

Process controller 71 can adjust the level of water layer 44 within the separation zone 13 by adjusting the water removal rate through water outlet 38 via control of level control valve 40. In particular embodiments, process controller 71 controls the water removal rate based upon output signals from Coriolis meters 66a-66e.

In other embodiments, process controller 71 controls the water removal rate based upon the water level signal provided to process controller 71 from water level meter 56.

In preferred embodiments, process controller 71 controls the water removal rate based upon output signal 76 and the water level signal.

What is claimed is:

1. A method, comprising:
introducing a feed, comprising oil, water and an oil/water emulsion, into a vessel having an oil outlet for removing oil from said vessel and a water outlet for removing water from said vessel;
providing within said vessel an emulsion layer having a depth and positioned between a lower water layer, having a water level within said vessel, and an upper oil layer;
removing a plurality of liquid samples from a plurality of distinct depths within said vessel;
passing each of said plurality of liquid samples through a fluid density and flow measurement device for measuring a specific gravity value of each of said plurality of liquid samples; and
processing said specific gravity values to yield an emulsion output signal indicative of an emulsion profile and an emulsion depth.

2. A method as recited in claim 1, further comprising:
introducing an emulsion breaking chemical into said vessel at a chemical addition rate; and
adjusting said chemical addition rate in response to said an emulsion output signal.

3. A method as recited in claim 1, further comprising:
removing water from said lower water layer at a water removal rate through said water outlet.

4. A method as recited in claim 3, further comprising:
controlling said water removal rate in response to said emulsion output signal.

5. A method as recited in claim 3, further comprising:
measuring said water level to thereby provide a water level signal representative of said water level; and
controlling said water removal rate in response to said water level signal.

6. A method as recited in claim 3, further comprising:
controlling said water removal rate in response to both said water level signal and said an emulsion output signal.

7. A method as recited in claim 3, further comprising:
controlling said chemical addition rate in response to both said water level signal and said emulsion output signal.

8. A method as recited in claim 1, wherein fluid density and flow measurement device is a Coriolis meter.

9. A method as recited in claim 4 wherein the water removal rate is controlled to adjust the vertical height of the emulsion layer within the vessel.

10. The method as recited in claim 1 wherein the specific gravity values are processed to provide particularized information about the emulsion layer.

11. A method comprising the steps of:
introducing a feed, comprising oil, water and an oil/water emulsion, into a vessel having an oil outlet for removing oil from said vessel and a water outlet for removing water from said vessel;
allowing the feed to separate within the vessel into an emulsion layer positioned between a lower water layer, having a water layer within the vessel, and an upper oil layer;
removing water from the lower water layer at a water removal rate through the water outlet;
removing a plurality of liquid samples from a plurality of distinct depths within said vessel;
passing each of said plurality of liquid samples through a fluid density and flow measurement device for measuring a specific gravity value of each of said plurality of liquid samples to provide measured specific gravity values for each liquid sample; and
controlling said water removal rate based upon said measured specific gravity values.

12. A method as recited in claim 11, further comprising:
processing said measured specific gravity values to yield an emulsion output signal indicative of an emulsion profile and an emulsion depth.

13. A method as recited in claim 11, further comprising:
introducing an emulsion breaking chemical into the vessel at a chemical addition rate; and
adjusting the chemical addition rate based upon the measured specific gravity values.

14. A method as recited in claim 11, wherein said water removal rate is controlled to adjust the vertical height of said emulsion layer within said vessel
